(19) United States
(12) Patent Application Publication
(10) Pub. No.: US 2018/0326398 A1
(43) Pub. Date: Nov. 15, 2018

(54) Apparatus, Methods and Systems For Fabricating Thin Nanoporous Membranes

(71) Applicants: GEORGIA TECH RESEARCH CORPORATION, Atlanta, GA (US); PHILLIPS 66 COMPANY, HOUSTON, TX (US)

(72) Inventors: Sankar Nair, Atlanta, GA (US); Jeffrey H. Drese, Bartlesville, OK (US); Kiwon Eum, Atlanta, GA (US); Ryan P. Lively, Atlanta, GA (US); Ali Rownaghi, Rolla, MO (US); Yash Tamhankar, Bartlesville, OK (US); Shaowei Yang, Atlanta, GA (US)

(73) Assignees: GEORGIA TECH RESEARCH CORPORATION, Atlanta, GA (US); PHILLIPS 66 COMPANY, Houston, TX (US)

(21) Appl. No.: 15/971,408

(22) Filed: May 4, 2018

Related U.S. Application Data
(60) Provisional application No. 62/504,016, filed on May 10, 2017.

(51) Int. Cl. B01J 20/22; B01D 69/14; B01J 20/08; B01J 29/04

(52) U.S. Cl. CPC B01J 20/226; B01D 69/147; B01J 2229/34; B01J 29/04; B01J 2229/183; B01J 20/08

(57) ABSTRACT

Embodiments of the present disclosure provide apparatuses, methods and systems for scalable fabrication of thin, nanoporous membranes useful in industrial applications. One embodiment of the present disclosure provides a molecular separation device configured to efficiently separate molecular species. In this particular embodiment, porous hollow fibers form a supporting scaffold for synthesis of a molecular organic framework (MOF) membrane. The MOF membrane may be synthesized on the inner or outer porous hollow fiber surface as well as within the porous fiber wall. Embodiments of the present disclosure provide a variety of methods for producing the aforementioned molecular separation devices as well as methods for producing MOF membranes.

### CROSS REFERENCE TO RELATED APPLICATIONS

This application claims priority to U.S. Provisional Patent Application 62/504,016, filed May 10, 2017, which is pending. The foregoing patent application is incorporated herein by reference in its entirety.

### STATEMENT REGARDING FEDERALLY SPONSORED RESEARCH

The technology disclosed herein was supported by United States Government award from the Advanced Research Projects Agency-Energy, Award No. ARPA-E 1906BQA. The government has certain rights in the invention.

### TECHNICAL FIELD OF THE INVENTION

The present invention relates generally to apparatus, methods and systems for scalable fabrication of thin, nanoporous membranes useful for separating molecular species in various industrial settings.

### BACKGROUND OF THE INVENTION

Advances in nanoporous membrane technology allow for the efficient separation of molecular species. However, one obstacle to the development of nanoporous membrane technology for use in various industrial separation applications is the inability to fabricate membranes made from materials, such as metal-organic frameworks (MOFs), on a sufficiently large-scale.

Methodologies for scalable MOF membrane fabrication, particularly MOFs formed from materials in the zeolitic imidazolate framework (ZIF) subclass of materials have more recently emerged. Interfacial Microfluidic Membrane Processing (IMMP) is a technique that involves contacting two oppositely positioned fluids at an interface, which may be on either the inner or outer surface of, or inside the bulk of, a hollow fiber support material. The two fluids contain different reactants necessary for the synthesis of a ZIF membrane. When reactants within the two fluids come into contact at an interface along the hollow fiber support material, synthesis of a MOF membrane may be initiated and membrane growth may continue along that interface until the reaction is halted. IMMP therefore allows for fabrication of high-quality ZIF membranes, including ZIF-8 membranes, which are particularly well-suited for molecular separation of industrially relevant materials, e.g., gases and hydrocarbon separation.

However, IMMP may not allow for efficient contact between oppositely positioned fluids in or on the hollow fiber support material. For example, oppositely positioned fluids having different reactants for the synthesis of MOF membranes may be hindered from making efficient contact along the interface of a porous hollow fiber support material or structure. Surface tension and mass transfer limitations may both hinder reactant fluid contact at an interface, particularly when the number of porous hollow fibers packed together becomes large, i.e., greater than 100 fibers per molecular membrane module. If inefficient contact between oppositely positioned reactant fluids is allowed, defective MOF membranes may be synthesized. Since conventional IMMP does not optimally localize oppositely positioned fluids at the hollow fiber support material interface, the range of permeances that is achievable may be limited, which would in turn lead to the formation of relatively thick membrane, e.g., between 3-20 microns.

### OBJECTS AND SUMMARY OF THE INVENTION

It is an object of the invention to provide apparatuses, methods and systems for scalable fabrication of thin nanoporous membranes useful in industrial applications.

It is another object of the invention to provide improved molecular separation devices comprising thin nanoporous MOF membranes.

It is yet another object of the invention to provide improved molecular separation devices comprising thin nanoporous MOF membranes comprising ZIFs, such as ZIF-8.

The foregoing and other objectives are achieved by providing a molecular separation device configured to efficiently separate molecular species is provided, the device including at least a porous hollow fiber or tubular support structure formed from at least one of polymer, ceramic, carbon, and metal; and a metal-organic framework (MOF) membrane having a thickness of less than 3 microns; wherein the device may be configured to include a MOF membrane formed on at least one of an inner porous hollow fiber or tubular surface, an outer porous hollow fiber or tubular surface, or within a porous hollow fiber or tube wall.

Various new processes for fabricating appropriate MOF membranes are also provided. For example, one such process includes fabricating a molecular separation device including a plurality of porous hollow fiber support structures formed from at least one of polymer, ceramic, carbon, and metal; localizing at least two fluids containing different reactants for membrane synthesis at an interface located on either an inner porous hollow fiber support surface, an outer porous hollow fiber support surface, or within a porous hollow fiber wall; and initiating a reaction to form the MOF membrane; wherein the reactants are supplied as at least one of a vapor, a liquid, or various solid forms.

A method for forming a molecular separation device configured to efficiently separate molecular species is also provided. In one example embodiment the method includes pre-assembling a plurality of porous hollow fiber support structures within a membrane fabrication module; applying a first reactant fluid including a metal salt and a second reactant fluid including an imidazole reactant to an interface along either an outer or an inner surface of the porous support hollow fibers; removing excess fluid surrounding the porous fibers of the membrane fabrication module; and heating remaining fluid on or in the porous fiber support structure of the membrane fabrication module to produce a solid imidazole membrane.

Another example method for forming a molecular separation device configured to efficiently separate molecular species is provided, the method including pre-assembling a plurality of porous hollow fiber support structures within a membrane fabrication module; applying a first fluid including a metal salt to either an outer or an inner surface of the porous support hollow fibers; converting the metal salt fluid to a solid metal-containing film by solvent evaporation; applying a second fluid including an imidazole reactant in a vapor form to either an outer or an inner surface of the porous support hollow fibers; reacting an imidazole reactant vapor with the metal-containing film to convert the metal-containing film into a MOF membrane.

Yet another example method for forming a molecular separation device configured to efficiently separate molecular species is provided, the method including pre-assembling of a plurality of porous hollow fibers to form a membrane fabrication module, wherein the porous hollow fibers are configured as a dual-layer hollow fiber having concentric layers including an inner and an outer layer having a thin coating of a metal-containing compound; applying an imidazole reactant in a vapor or a liquid form; and converting the metal-containing outer layer of the fiber into a MOF membrane by vapor-phase exchange of the imidazole reactant throughout the layer.

Numerous other structures, devices, methods of manufacture and use of related separation devices including thin nanoporous membranes are also described herein as representative example embodiments of the instant disclosure.

The foregoing and other objects, features, aspects and advantages of the invention will become more apparent from the following detailed description of the invention when considered in conjunction with the accompanying drawings.

### BRIEF DESCRIPTION OF THE DRAWINGS

FIG. 1 shows cross sectional scanning electron microscope (SEM) images of ZIF-8 membrane grown on a porous α-alumina hollow fiber;

FIG. 2 graphically illustrates equimolar C₃H₆/C₃H₈ gas separation performance of ZIF-8 membrane grown on the outer surface of a porous α-alumina hollow fiber of length 13 cm;

FIG. 3 shows SEM images of (a) bare porous carbon hollow fiber, and (b) ZIF-8 membrane grown on the carbon fiber.

### DESCRIPTION OF SEVERAL EXAMPLE EMBODIMENTS

In the following detailed description of the preferred embodiments, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

Embodiments of the present disclosure provide molecular separation devices configured to efficiently separate molecular species. Further embodiments provide for molecular devices including at least a porous hollow fiber formed from at least one of polymer, ceramic, carbon, and metal and a metal-organic framework (MOF) membrane. In certain embodiments, devices described in the disclosure employ a MOF membrane having a thickness of less than 3 microns. In other embodiments, the devices are configured to include a MOF membrane formed on at least one of an inner porous hollow fiber or tubular surface, an outer porous hollow fiber or tubular surface, or within a porous hollow fiber or tube wall.

Other embodiments provide molecular separation devices configured to include porous hollow fibers having a diameter of less than about 2,000 microns. In still other embodiments the diameter of porous hollow fiber may range from: about 0.1 to 2,000 microns; about 0.1 to 1,500 microns, about 0.1 to 1,000 microns, about 0.1 to 500 microns, about 0.1 to 250 microns, about 0.1 to 100 microns, about 0.1 to 50 microns, about 0.1 to 25 microns, about 0.1 to 10 microns, and about 0.1 to 1 microns.

In other embodiments, the molecular separation devices are configured to include porous hollow fiber support structures described in terms of their physical characteristics. In certain embodiments of the present disclosure, porous hollow fiber structure may be described by their porosity, which is often dependent upon the volume of the structure. For example, a porous structure having of total volume V, the volume of the sold phase may be Vs while the volume of the pore phase, i.e., the openings, may be Vp wherein V=Vs+Vp. The volume fraction is a normalized variable which may be generally useful in describing porous hollow fiber structures of the present disclosure.

In certain embodiments, the porous, hollow fiber structures may be described by their volume fraction. If, for example, the volume fraction of the pore phase, which may be commonly referred to as porosity, is denoted Φ=Vp/V, then the solid volume fraction may be denoted 1−Φ. While the volume fraction calculation has no units, the volume fraction may be expressed as a percentage. In certain embodiments, the porous hollow fiber structures of the present disclosure may have a volume fraction of less than about 100%, about 90%, about 80%, about 70%, about 60%, about 50%, about 40%, about 30%, about 20%, and about 10%. In other embodiments, porous hollow fiber structures of the present disclosure may have a volume fraction of less than about 90%.

Embodiments of the present disclosure provide molecular separation devices which may be configured to separate molecular species across a dynamic size range, i.e., from about 0.1 to about 1,000 nm. In certain embodiments molecular separation of species using separation devices of the present disclosure may be achieved when the molecular species range in size from: about 0.1 to about 500 nm, about 0.1 to about 100 nm, about 0.1 to about 50 nm, about 0.1 to about 10 nm, about 0.1 to about 1 nm, about 0.1 to about 0.75, about 0.1 to about 0.5 nm, about 0.2 to about 0.75 nm, and about 0.25 nm to about 0.65 nm.

In various other embodiments, the molecular separation devices are configured to separate molecular species including at least one gas and/or at least one hydrocarbon. In certain embodiments, molecular separation devices of the present disclosure may be configured to separate gases including at least one of hydrogen, carbon dioxide, oxygen and nitrogen. In other embodiments, molecular separation devices of the present disclosure may be configured to separate hydrocarbons including at least one of methane, ethylene, ethane, propylene, propane, n-butane, i-butane, and butene isomers.

Various other embodiments provide molecular separation devices including a molecular separation membrane having varying permeation characteristics. In certain embodiments, the gas separation properties of membranes of the present disclosure may be inversely proportional. For example, in certain embodiments the more permeable a molecular separation membrane is, the less selective the molecular separation membrane may be. In other embodiments, permeation selectivity ranging from about 1 to about 100 is provided. Certain other embodiments provide molecular separation devices having permeation selectivity of: about 95, about, 90, about 85, about 80, about 75, about 70, about 65, about 60, about 55, about 50, about 45, about 40, about 35, about 30, about 25, about 20, about 15, about 10, about 5, and about 2.

Other embodiments provide molecular separation devices operable over a broad temperature range. Further embodiments provide a molecular separation device configured to separate molecular species at a temperature ranging from about 1° C. to about 150° C. In certain embodiments, the molecular separation devices are configured to separate molecular species at temperatures ranging from: about 1° C. to about 125° C., about 1° C. to about 100° C., about 1° C. to about 75° C., about 1° C. to about 50° C., about 1° C. to about 25° C., about 10° C. to about 125° C., about 10° C. to about 100° C., about 15° C. to about 100° C., about 20° C. to about 100° C., about 25° C. to about 100° C.

Further embodiments provide methods and processes for making and forming molecular separation devices by exposing reactants to a wide range of temperatures to initiate molecular separation membrane formation. Other embodiments provide methods and processes for making and forming molecular separation membranes by subjecting reactant fluids to temperatures ranging from about 1° C. to about 150° C. in order to initiate formation of the molecular membrane. In certain embodiments, the molecular separation membranes of the present disclosure may be formed at reaction temperatures ranging from: about 1° C. to about 125° C., about 1° C. to about 100° C., about 1° C. to about 75° C., about 1° C. to about 50° C., about 1° C. to about 25° C., about 10° C. to about 125° C., about 10° C. to about 100° C., about 15° C. to about 100° C., about 20° C. to about 100° C., about 25° C. to about 100° C.

According to one aspect of the disclosure, various fluidic methods and techniques intended to overcome the potential limitations of the original IMMP method are considered. Certain previously disclosed features of IMMP (as seen, for example, in international publication WO2014/200613) such as the pre-assembly of a membrane module consisting of closely packed fibers, and the controlled feeding of reactant fluids at one or both sides (‘bore’ and ‘shell’), are retained or extended in the present disclosure.

Various other embodiments provide for hollow fiber pre-assembly, or “mounting” of hollow fibers, which function as a scaffold for the production of thin, nanoporous membranes. For example, metal or plastic plates, O-rings, compression fittings, and compression “potting” compounds may be used to pre-assemble hollow fibers. In one embodiment, porous hollow fibers are bundled together in a chamber and embedded in epoxy at the ends. The porous hollow fiber ends extend through the epoxy sealant. The hollow fiber form “tubes,” and the open bore of the hollow fiber is accessible to a fluid flow. A flow of fluids may be introduced into and through the bore of the hollow fibers using, for example, a syringe pump.

In one embodiment, a continuous flow of fluids may be introduced through the bore of the hollow fibers and/or the shell side (external surface) of the hollow fibers. In another embodiment, an intermediate flow of fluid may be introduced through the bore of the hollow fibers and/or the shell side (external surface) of the hollow fibers. In another embodiment, a single “dose” of fluid may be introduced through the bore of the hollow fibers and/or the shell side (external surface) of the hollow fibers.

Several other new aspects of the technology are also disclosed. These new aspects primarily address two important issues: (1) the localization of reactants for the purpose of fabricating very thin (for example, less than the thickness obtained by previously known IMMP methods, and with a preferred thickness of <1 micron) MOF/ZIF membranes; and (2) vapor-phase or solid-phase introduction of at least one of the reactants to overcome surface tension and mass transfer limitations associated with the liquid-phase introduction.

Other embodiments provide an assembly for synthesis of a molecular membrane module. In certain embodiments, a porous hollow fiber support structure provides the assembly for synthesis of a molecular separation membrane.

Other embodiments provide a process for fabricating MOF membranes for use in molecular separation devices. In certain embodiments, the process for fabricating MOF membrane may use porous hollow fiber support structure comprising at least one of polymer, ceramic, carbon, and metal, localizing at least two fluids having different reactants for membrane synthesis at an interface located at either an inner porous hollow fiber support or an outer porous hollow fiber support surface or within a porous hollow fiber wall, and initiating reaction to form the MOF membrane. In certain embodiments, the reactants for MOF membrane synthesis may be supplied as at least one of vapor, liquid, or solid forms.

In certain embodiments, the process for fabricating MOF membranes for use in molecular separation devices may include a metal ion. In certain embodiments, the metal ion may include Zn2+, Co2+, or Cd2+ and may be in a salt form.

In certain embodiments, the process for fabricating MOF membranes for use in molecular separation devices includes a linker. In certain other embodiments, the linker includes at least one of 2-carboxyimidazole linker or 2-methylimidazole linker.

Further embodiments provide methods for forming molecular separation devices for separating molecular species. Generally, methods for forming molecular separation devices according to the present disclosure may include pre-assembling a plurality of porous hollow fiber support structures within a membrane fabrication module. At least two fluids containing MOF membrane reactants may be applied to the porous support hollow fiber structures. Where the MOF membrane reactant fluids make contact, i.e., at an interface, the fluids may be reacted under conditions to produce desired molecular separation membrane, i.e., MOF membrane. In certain embodiments, removal of excess fluids from the porous hollow fiber support structures of the membrane fabrication module may be beneficial prior to initiation of membrane forming reaction. In other embodiments, reactants may be prepared using a solvent including methanol, ethanol, water, dimethylformamide, dimethylacetamide, or other suitable solvents.

In further embodiments, methods for forming molecular separation devices may involve heating the reactant fluids to initiate and/or propagate membrane formation reaction. In certain embodiments, methods for forming molecular separation membranes may employ heating reactant fluid on or in the porous fiber support structure of the membrane fabrication module in order to initiation and/or propagate formation of solid molecular separation membrane, e.g., imidazole membrane.

In certain embodiments, methods for forming molecular separation devices may involve a process including the step-wise addition of fluids. For example, in one embodiment, a first fluid including a reactant, e.g., metal salt containing fluid, may be introduce to either an outer or an inner surface of the porous support hollow fibers. The first fluid reactant, e.g., metal salt containing fluid, may then be converted to a solid, i.e., solid metal-containing film, by various processes including solvent evaporation. Conversion of the first reactant fluid to a solid can be achieved by subjecting the first fluid reactant to ambient conditions, heating, or crystallizing by cooling past supersaturation.

In certain embodiments employing a step-wise process, a second reactant fluid, e.g., imidazole reactant fluid, may be introduced. For example, the second reactant may be provided in a vapor form to either an outer or an inner surface of the porous support hollow fiber support structure and may be reacted with the solid formed by the first reactant fluid to produce a molecular separation membrane, e.g., MOF membrane. In certain embodiments, the imidazole vapor may be obtained by evaporation of a liquid solution of an imidazole in a solvent or by evaporation from a pure imidazole liquid. In other embodiments, the MOF membrane formed is a ZIF membrane.

Other embodiments provide molecular separation devices which may be configured to efficiently separate molecular species by pre-assembling of a plurality of porous hollow fibers to form a membrane fabrication module. The plurality of porous hollow fibers may be configured as a dual-layer of hollow fibers having two concentric layers including an inner and an outer layer, and including a thin coating of a metal-containing compound. In certain embodiments, the thin coating of metal-containing compound includes transition metal compounds, e.g., zinc oxide, cobalt oxides, or cadmium oxide. In certain embodiments, the thin coating of a metal-containing compound is less than about 1 micron. In certain embodiments, the imidazole reactant may be applied in either a vapor or a liquid form. In other embodiments, converting the metal-containing outer layer of the fiber into a MOF membrane may be achieved by vapor-phase exchange of the imidazole reactant throughout the layer.

Exemplary, non-limiting embodiments of the present disclosure are provided as follows.

### Example 1: ZIF-8 Membrane on Ceramic (Alumina) Hollow Fibers

In one example embodiment, α-alumina hollow fiber may serve as the support structure for synthesis of a molecular separation membrane. For example, α-alumina hollow fibers may be mounted with epoxy inside a membrane module. One possible mounting procedure is described as follows. After allowing the epoxy to be cured for approximately 24 hours, a plastic tube or the like is inserted through the outer wall of the molecular separation module. Subsequently, the molecular separation module is disposed vertically, and an epoxy is introduced through the bore side of the plastic tube. Once the plastic tube is filled with epoxy, the module is again stored for an additional period, e.g., 24 hours, to ensure the epoxy is fully cured. Ordinarily skilled artisans will appreciate that the porous hollow fiber pre-assembly procedure disclosed above may be repeated on the other side of the molecular separation module to secure the opposite end of the porous hollow fiber support structure. Once the epoxy is fully cured, the plastic tubes for loading epoxy are removed to complete the pre-assembly process, i.e., mounting of the supporting porous hollow fibers.

Various other example embodiments include fabrication or synthesis of a molecular separation membrane. In one specific though non-limiting embodiment, membrane synthesis is achieved by dissolving about 1.32 g zinc acetate dehydrate in about 15 ml DI-water/N,N-dimethyl acetamide (DMA) (v/v ratio of about 2:1) solution. In addition, about 1.00 g of 2-methylimidazole (2-MeIM) ligand is dissolved in about 15 ml DI-water/DMA (v/v ratio of about 2:1) solution. 2-MeIM ligand solution is then added dropwise to a metal solution with a flow rate of about 5 ml/min using a syringe pump at about 25° C. under stirring conditions. The solution mixture is stirred up to about 5 minutes, and then introduced into the shell side of the molecular separation fabrication/synthesis module.

Further, weak vacuum (about 7 PSIA) conditions can be applied to the bore side of the porous hollow fiber structure, for example, for about 3 minutes. Excess fluid is then removed from the membrane fabrication/synthesis module. Curing of the membrane is achieved by placing the module in an oven and heating at about 200° C. for about 15 minutes, then cooling the module to room temperature.

Further processing of the ZIF-8 membrane may also be performed. For example, the ZIF-8 membrane can be solvent-exchanged with methanol for about 1 day and dried for about 12 hours at room temperature. Also, PDMS capping may be applied using about 9 weight % PDMS/heptane solution and applying 2 all droplet to each porous hollow fiber end and curing at about 120° C. for about 2 hours.

Generally, example embodiments provide nanoporous membranes for molecular separation. As a heterogeneous flow of molecules encounter nanoporous membranes of the present disclosure, a pressure differential is created. Separation of the heterogeneous mixture occurs as pressure drives a specific, desirable molecular species through the nanoporous membrane while retarding one or more undesirable molecular species. While increasing pressure may drive separation throughput, selectivity may be compromised as pressure increases. Selection of a specific separation pressure may be specific to the molecular targets to be separated. For example, in certain embodiments, a separation pressure range may be selected from: about 0.1 to about 50 bar, from about 0.1 to about 45 bar, about 0.1 to about 40 bar, about 0.1 to about 35 bar, about 0.1 to about 30 bar, about 0.1 to about 25 bar, about 0.1 to about 20 bar, about 0.1 to about 15 bar, about 0.1 to about 10 bar, about 0.1 to about 5 bar, about 0.1 to about 3 bar. In certain embodiments, the nanoporous membranes of the present disclosure have an operable separation pressure range from about 1 to about 42 bar, where desirable throughput and selectivity may be achieved. In other embodiments, the nanoporous membranes of the present disclosure have an operable separation pressure range from about 6 ATM to about 9 ATM, where desirable throughput and selectivity may be achieved.

Molecular separation using thin, nanoporous membranes of the present disclosure may be described by gas permeance values expressed as GPU. Generally, permeance is the degree to which a material, e.g., a thin, membrane nanoporous molecular separation device, transmits another substance. Embodiments of the present disclosure provide a thin, nanoporous membranes having a permeance ranging from: about 0.01 to about 10,0000 GPU, about 0.01 to about 10,000 GPU, about 0.01 to about 1,000 GPU, about 0.01 to about 100 GPU, about 0.01 to about 10 GPU, about 0.01 to about 1 GPU. In certain embodiments of the present disclosure, a thin, nanoporous membrane having a permanence ranging from about 0.1 to about 10,000 is provided.

Those of skill in the relevant arts will readily appreciate that the specific times, temperatures, and processes described above are representative in nature only, and that many other specific parameters can be added, deleted, or interchanged without departing from the scope of the instant disclosure.

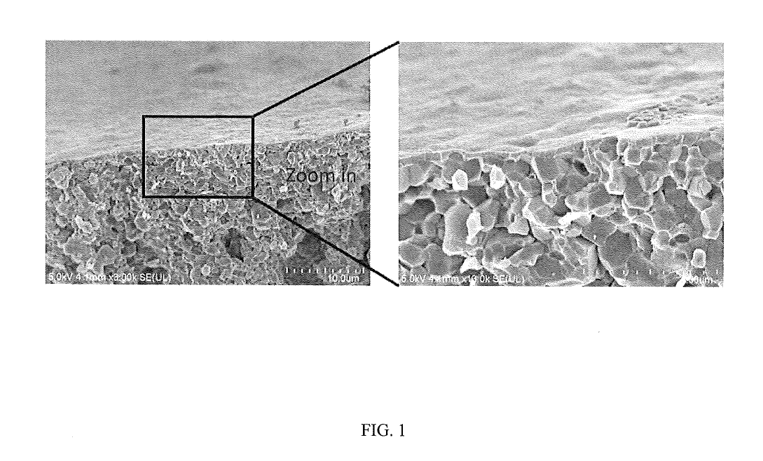

FIG. 1 shows cross-sectional SEM images of the ZIF-8 membrane grown at the outer surface of an alumina fiber support structure. In this example embodiment, a ZIF-8 membrane having a thickness of less than about 1 micron was grown at the outer surface of the porous hollow fiber support structure, e.g., α-alumina fiber.

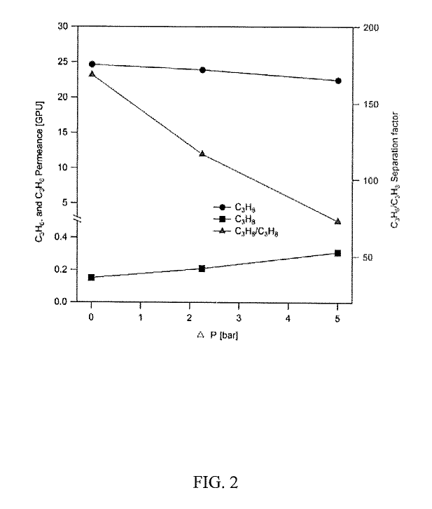

The separation performance of the exemplary ZIF-8 membrane was tested with an equimolar binary mixture (C₃H₆/C₃H₈) at a feed pressure of about 1 bar, and the resulting data is illustrated in FIG. 2. The ZIF-8 membrane produced according to this example embodiment of the present shows a C₃H₆/C₃H₈ separation factor of about 169 with propylene permeance of about 25 GPU.

ZIF-8 membranes produced according to other embodiments were also tested to evaluate separation pressure dependence in a binary C₃H₆/C₃H₈ mixture separation paradigm. For example, a binary C3H6/C3H8 mixture was separated using a ZIF-8 membrane produced according to one example embodiment and then tested at elevated pressure at about 25° C. Once again, clear molecular sieving effects were observed, with the membrane maintaining a C₃H₆/C₃H₈ separation factor of more than 70 up to about 6 bar feed pressure.

### Example 2: ZIF-8 Membrane on Macroporous Carbon Hollow Fibers

Another example embodiment achieves formation of a molecular separation device having a carbon fiber porous hollow support structure. In this example embodiment, the procedure disclosed in Example 1 was applied to macroporous carbon fibers.

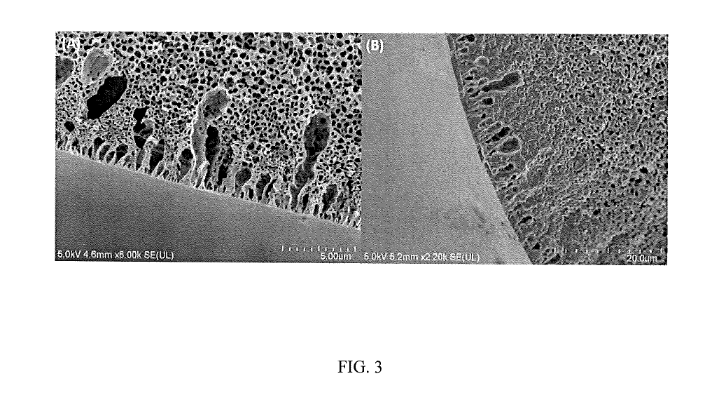

FIG. 3 shows a cross sectional SEM image of an exemplary ZIF-8 membrane grown at an outer surface of a carbon fiber support structure. The SEM image illustrates that an exemplary ZIF-8 membrane formed on the outer surface of a carbon fiber support structure is less than about 1 micron in thickness.

Table 1 summarizes the separation performance of three exemplary embodiments of ZIF-8 membranes produced on carbon fibers support structures. Separation of an equimolar mixed gas, i.e., C3H6/C3H8, was measured at about 1 bar feed pressure at about 25° C. All exemplary ZIF-8 membranes according to exemplary embodiments of the present disclosure show excellent molecular sieving performance and reproducibility. For the three exemplary embodiments tested, the average C3H6/C3H8 separation factor and propylene permeance were measured to be 15, and 17 GPU, respectively.

TABLE 1

| Index | Propylene | Propane | Separation |
|---|---|---|---|
| 1 | 10 GPU | 0.4 GPU | 22 |
| 2 | 23 GPU | 2.0 GPU | 11.5 |
| 3 | 17 GPU | 1.4 GPU | 12 |

### Example 3: Multi-Fiber Modules

Another example embodiment provides for a molecular separation device produced using a support structure that includes multiple porous hollow fibers. The procedures described herein, i.e., in Examples 1 and 2, were adapted to fabricate a molecular separation module having multiple support fibers with differing fiber lengths.

Table 2 summarizes the permeation characteristics of ZIF-8 membranes synthesized on either ceramic, i.e., α-alumina, or carbon fiber support structures within a molecular membrane module. The porous hollow support structures, i.e., α-alumina or carbon fiber, may vary in length and number.

For example, in one embodiment, the number of porous hollow fibers included in the support structure range from about 1 to more than one (1) million fibers. In various other embodiments, the number of porous hollow fibers included in the support structure range from fewer than about 1,000,000 fibers, fewer than about 100,000 fibers, fewer than about 10,000 fibers, fewer than about 1,000 fibers, fewer than about 100 fibers, fewer than about 75 fibers; fewer than 50 fibers; fewer than about 25 fibers; fewer than about 20 fibers; fewer than about 15 fibers; fewer than about 10 fibers; fewer than about 5 fibers; and fewer than about 3 fibers.

In other embodiments, the length of porous hollow fibers included in the support structure may range from: less than about 50 cm; less than about 25 cm; less than about 20 cm; less than about 15 cm; less than about 5 cm; and less than about 3 cm.

Table 2 shows that C3H6-selective membranes consistently achieve separation selectivities ranging from a factor of about 15 to a factor of about 169 at 1 bar, and permeances from about 13 to about 32 GPU.

TABLE 2

| | | Number | Length | | | |
|---|---|---|---|---|---|---|
| | Type of | of | of | Propylene | Propane | Separation |
| Index | fiber | fiber | fiber | Permeance | Permeance | Factor |
| 1 | Carbon | 5 | 5 cm | 32 GPU | 2.4 GPU | 13 |
| 2 | Carbon | 10 | 5 cm | 14 GPU | 0.9 GPU | 15 |
| 3 | α- | 3 | 5 cm | 15 GPU | 0.3 GPU | 51 |
| | Alumina | | | | | |
| 4 | α- | 3 | 13 cm | 25 GPU | 0.2 GPU | 169 |
| | Alumina | | | | | |
| 5 | α- | 10 | 5 cm | 13 GPU | 0.1 GPU | 111 |
| | Alumina | | | | | |

Although the present invention has been described in terms of specific embodiments, it is anticipated that alterations and modifications thereof will no doubt become apparent to those skilled in the art. It is therefore intended that the following claims be interpreted as covering all alterations and modifications that fall within the true spirit and scope of the invention.

What is claimed is:

1. A molecular separation device configured to efficiently separate molecular species, comprising:
a porous hollow fiber support structure formed from at least one of a polymer, a ceramic, a carbon, and a metal; and
a molecular organic framework (MOF) membrane having a thickness of less than 3 microns;
wherein the device is configured to include a MOF membrane formed on at least one of an inner porous hollow fiber surface, an outer porous hollow fiber surface, or within a porous hollow fiber wall.

2. The device of claim 1, wherein the porous hollow fiber support structures have a volume fraction of less than 90%.

3. The device of claim 1, wherein the porous hollow fiber support structures have an outer diameter of less than about 2000 microns.

4. The device of claim 1, wherein the MOF membrane is configured to have a thickness of about 1 micron or less.

5. The device of claim 1, wherein the MOF is a zeolitic imidazolate framework (ZIF).

6. The device of claim 5, wherein the ZIF includes at least one of ZIF-8, ZIF-90, or a hybrid, mixed-linker ZIF.

7. The device of claim 1, wherein the MOF membrane is configured to have permeances from about 10 GPU to about 10,000 GPU.

8. The device of claim 1, wherein the MOF membrane is configured to separate molecular species having a size range from about 0.25 nm to about 0.65 nm.

9. The device of claim 1, wherein the MOF membrane is configured to separate molecular species including at least one of gases and hydrocarbons.

10. The device of claim 9, wherein the MOF membrane is configured to separate gases including at least one of hydrogen, carbon dioxide, oxygen, and nitrogen.

11. The device of claim 9, wherein the MOF membrane is configured to separate hydrocarbons including at least one of methane, ethylene, ethane, propylene, propane, n-butane, i-butane, and butene isomers.

12. The device of claim 11, wherein the MOF membrane is configured to include a permeation selectivity of at least about 10 for separation of a propylene from a propane.

13. The device of claim 11, wherein the membranes are configured to operate under conditions including a pressure between about 1 to about 42 bar and a temperature between about 25 to about 100° C.

14. The device of claim 10, wherein the MOF membrane is configured to include a permeation selectivity of at least about 100 for separation of a hydrogen from a propane.

15. The device of claim 14, wherein the membranes are configured to operate under conditions including a pressure between about 1 to about 42 bar and a temperature between about 25 to about 100° C.

16. The device of claim 14, wherein the MOF membrane is configured to operate under conditions including a pressure between about 1 to about 42 bar and a temperature between about 25 to about 100° C.

17. A process for fabricating MOF membranes comprising:
fabricating a molecular separation device including porous hollow fiber support structures formed from at least one of a polymer, ceramic, carbon, and metal;
localizing at least two fluids containing different reactants for membrane synthesis at an interface located at one of the following of the porous hollow fiber support structures: on an inner porous hollow fiber support surface, at an outer a porous hollow fiber support surface, or within a porous hollow fiber wall; and
initiating a reaction to form the MOF membrane;
wherein the reactants are supplied as at least one of vapor, liquid, or solid forms.

18. The process of claim 17, further comprising a metal ion comprising one or more of Zn2+, Co2+, or Cd2+ in the form of a salt.

19. The process of claim 17, wherein the reactants include at least one of an imidazole linker molecule and a 2-carboxyimidazole.

20. The process of claim 20, wherein the imidazole linker includes 2-methylimidazole.

21. A method for forming a molecular separation device configured to efficiently separate molecular species, comprising:
pre-assembling a plurality of porous hollow fiber support structures within a membrane fabrication module;
applying a first reactant fluid including a metal salt and a second reactant fluid include an imidazole reactant to an interface along either an outer or an inner surface of the porous support hollow fibers;
removing excess first and second reactant fluid surrounding the porous fibers of the membrane fabrication module; and
heating remaining first and second reactant fluid on or in the porous fiber support structure of the membrane fabrication module to produce a solid imidazole membrane.

22. The method of claim 21, wherein the reactant fluid is prepared using a solvent including at least one of methanol, ethanol, water, dimethylformamide, or dimethylacetamide.

23. The method of claim 21, wherein the produced imidazole membrane is a ZIF.

24. A method for forming a molecular separation device configured to efficiently separate molecular species, comprising:
pre-assembling of a plurality of porous hollow fiber support structures within a membrane fabrication module;
applying a first fluid including a metal salt to either an outer or an inner surface of the porous support hollow fibers;
converting the fluid containing the metal salt to a solid metal-containing film by solvent evaporation;
applying a second fluid including an imidazole reactant in a vapor for ii to either an outer or an inner surface of the porous support hollow fibers; and
reacting the imidazole reactant vapor with the metal-containing film to convert the metal-containing film into an MOF membrane.

25. The method of claim 24, wherein conversion of metal salt fluid to a solid metal-containing film is achieved by at least one of the following: subjecting to ambient conditions, heating, or crystallizing by cooling past supersaturation.

26. The method of claim 24, wherein the imidazole vapor is obtained by evaporation of a liquid solution of an imidazole in a solvent or by evaporation from a pure imidazole liquid.

27. The method of claim 24, wherein the MOF membrane is a ZIF membrane.

28. A method for forming a molecular separation device configured to efficiently separate molecular species, comprising:
pre-assembling a plurality of porous hollow fibers to form a membrane fabrication module, wherein the porous hollow fibers are configured as a dual-layer hollow fiber having two concentric layers including an inner and an outer layer having a thin coating of a metal-containing compound;
applying an imidazole reactant in a vapor or a liquid form; and
converting the metal-containing outer layer of the fiber into an MOF membrane by vapor-phase exchange of the imidazole reactant throughout the layer.

29. The method of claim 28, wherein the thin coating of a metal-containing compound has a thickness of less than about 1 micron.

30. The method of claim 28, wherein the metal-containing compound includes zinc oxide, cobalt oxides, or cadmium oxide.
